(19) United States
(12) Patent Application Publication
(10) Pub. No.: US 2025/0308207 A1
(43) Pub. Date: Oct. 2, 2025

(54) VEHICLE APPEARANCE INFORMATION COLLECTION DEVICE, METHOD AND COMPUTER PROGRAM FOR COLLECTING VEHICLE APPEARANCE INFORMATION

(71) Applicant: TOYOTA JIDOSHA KABUSHI KAISHA, Toyota-shi (JP)

(72) Inventor: Yusuke KASHIBA, Tokyo-to (JP)

(73) Assignee: TOYOTA JIDOSHA KABUSHI KAISHA, Toyota-shi (JP)

(21) Appl. No.: 19/045,863

(22) Filed: Feb. 5, 2025

(30) Foreign Application Priority Data
Mar. 28, 2024 (JP) 2024-053409

(51) Int. Cl. G06V 10/764; H04W 4/40

(52) U.S. Cl. CPC G06V 10/764; H04W 4/40; G06V 2201/07

(57) ABSTRACT

A vehicle appearance information collection device includes a processor configured to: detect a target vehicle from a sensor signal generated by a sensor of a host vehicle in a case where a position of the target vehicle indicated by vehicle location information is included in a detection range of the sensor, calculate, for each of at least one component of the target vehicle, a confidence score that the component is represented in a region in which the target vehicle is represented on the sensor signal when the target vehicle is detected from the sensor signal, and transmit the sensor signal to a server via a wireless communication terminal mounted on the host vehicle when the target vehicle is detected and the confidence score of any one of the at least one component is less than a predetermined detection threshold.

### FIELD

The present invention relates to a vehicle appearance information collection device, a vehicle appearance information collection method, and a computer program for collecting vehicle appearance information for acquiring appearance information representing an appearance of a vehicle.

### BACKGROUND

A monitoring service using a vehicle has been proposed (see Japanese Unexamined Patent Publication No. JP2022-158104A).

In the technique disclosed in JP2022-158104A, a server, which is a monitoring device, instructs a vehicle to acquire appearance data of a monitoring target designated by a user, and detects the presence or absence of a state change of the monitoring target based on the appearance data received from the vehicle.

### SUMMARY

When all of images representing an appearance of an object to be monitored obtained by capturing the object from the vehicle are transmitted to a server, an image insufficient for use in inspecting the appearance of the object may be transmitted to the server. As a result, the amount of communication is unnecessarily increased.

Therefore, it is an object of the present invention to provide a vehicle appearance information collection device that can transmit appearance information of a vehicle to be monitored to a server, the appearance information being suitable for inspecting an appearance state of the vehicle, while suppressing an increase in an amount of communication.

According to one embodiment, a vehicle appearance information collection device is provided. The vehicle appearance information collection device includes a processor configured to: determine whether or not a position of a target vehicle indicated by vehicle location information is included in a detection range of a sensor of a host vehicle, detect the target vehicle from the sensor signal generated by the sensor when the position of the target vehicle is included in the detection range, calculate, for each of at least one component of the target vehicle, a confidence score that the component is represented in a region in which the target vehicle is represented on the sensor signal by inputting the region to a classifier trained in advance so as to detect the at least one component of the target vehicle, when the target vehicle is detected from the sensor signal, and transmit the sensor signal to a server via a wireless communication terminal mounted on the host vehicle when the target vehicle is detected and the confidence score of any one of the at least one component is less than a predetermined detection threshold.

In one embodiment, the processor is further configured to determine a relative positional relationship between the target vehicle and the host vehicle when the position of the target vehicle is included in the detection range. The processor calculates the confidence score of a component visible from the sensor in the relative positional relationship between the target vehicle and the host vehicle among the at least one component, and transmit the sensor signal to the server only when the confidence score of the component visible from the sensor among the at least one component is less than the detection threshold.

The vehicle appearance information collection device according to the present disclosure has an advantageous effect of being able to transmit appearance information of a vehicle to be monitored to a server, the appearance information being suitable for inspecting an appearance state of the vehicle, while suppressing an increase in an amount of communication.

### BRIEF DESCRIPTION OF DRAWINGS

FIG. 1 schematically illustrates the configuration of a vehicle management system equipped with a vehicle appearance information collection device.

FIG. 2 illustrates the hardware configuration of a vehicle appearance information collection device according to an embodiment.

FIG. 3 is a functional block diagram of a processor of the vehicle appearance information collection device.

FIG. 4 is a schematic explanatory diagram of a vehicle appearance information collection process.

FIG. 5 is an operation flowchart of the vehicle appearance information collection process.

### DESCRIPTION OF EMBODIMENTS

Hereinafter, a vehicle appearance information collection device, a vehicle appearance information collection method executed by the vehicle appearance information collection device, and a computer program for collecting vehicle appearance information will be described with reference to the drawings. Hereinafter, a vehicle equipped with the vehicle appearance information collection device may be referred to as a host vehicle. The vehicle appearance information collection device determines whether or not the position of a vehicle to be monitored (hereinafter, sometimes referred to as a target vehicle) is included in a detection range of a sensor that is mounted on the host vehicle and detects a situation around the host vehicle. When the target vehicle is included in the detection range, the vehicle appearance information collection device attempts to detect the target vehicle from the sensor signal obtained by the sensor. Further, when the target vehicle is detected from the sensor signal, the vehicle appearance information collection device inputs a region in which the target vehicle is represented on the sensor signal to a classifier for detecting a vehicle component, thereby calculating, for each of the at least one component of the target vehicle, a confidence score representing the likelihood that the component is represented in the region. Then, when the target vehicle is detected from the sensor signal and the confidence score of any of the components is less than a predetermined detection threshold value, there is a possibility that some damage or deformation has occurred in the component or the component is dirty. Therefore, the vehicle appearance information collection device transmits the sensor signal to a server via a wireless communication terminal mounted on the host vehicle as the appearance information representing the appearance of the target vehicle. On the other hand, when the target vehicle is not detected from the sensor signal, there is a high possibility that the target vehicle is not represented in the sensor signal, and therefore, the vehicle appearance information collection device does not transmit the sensor signal to the server. Further, even when the target vehicle is detected from the sensor signal and the confidence score of each component is equal to or higher than the detection threshold value, there is a high possibility that there is no abnormality in the target vehicle, and therefore, the vehicle appearance information collection device also does not transmit the sensor signal to the server. As described above, the vehicle appearance information collection device limits the sensor signal to be transmitted to the server to a sensor signal that is highly likely to represent a defect in the appearance of the target vehicle, and transmits the sensor signal suitable for inspecting the appearance state of the target vehicle to the server while suppressing an increase in a communication amount.

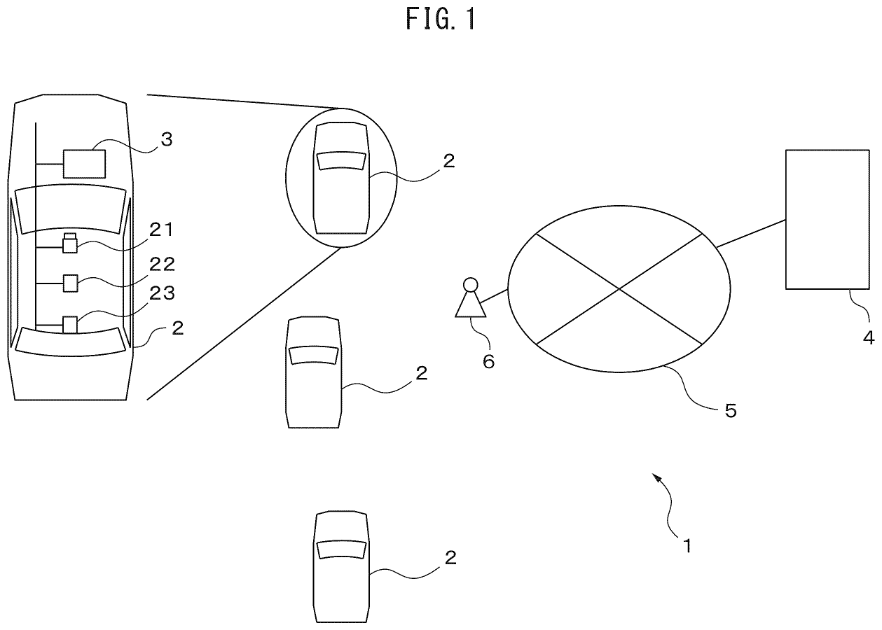

FIG. 1 schematically illustrates the configuration of a vehicle management system equipped with a vehicle appearance information collection device. In the present embodiment, the vehicle management system 1 includes a plurality of vehicles 2, a vehicle appearance information collection device 3 mounted on each of the plurality of vehicles 2, and a server 4. The vehicle appearance information collection device 3 is connected to the server 4 via a wireless base station 6 and a communication network 5 by accessing the wireless base station 6 connected to the communication network 5 to which the server 4 is connected via a gateway (not shown) or the like. Although only one wireless base station 6 is illustrated in FIG. 1, a plurality of wireless base stations 6 may be connected to the communication network 5.

The server 4 transmits to any of the plurality of vehicles 2, vehicle location information indicating the position of any vehicle of the other vehicles in order to instruct the acquisition of the appearance information of the vehicle whose position is indicated. Among the plurality of vehicles 2, the vehicle that has received the vehicle location information attempts to take a picture of the vehicle identified by the vehicle location information among the plurality of vehicles 2. Among the plurality of vehicles 2, the vehicle that has received the vehicle location information is an example of the host vehicle, and the vehicle identified by the vehicle location information is an example of the target vehicle.

First, the vehicle appearance information collection device 3 mounted on each vehicle 2 and each vehicle 2 will be described. In the present embodiment, each of the plurality of vehicles 2 may be a taxi vehicle controlled by autonomous driving, but is not limited thereto. At least one of the plurality of vehicles 2 may be a taxi vehicle manually driven by a driver. Each of the plurality of vehicles 2 may be a vehicle used for applications other than a taxi, for example, a vehicle for package delivery. Furthermore, the application of some of the vehicles 2 may be different from that of the others of the vehicles 2.

Each vehicle 2 includes a camera 21, a GPS receiver 22, a wireless communication terminal 23, and a vehicle appearance-information collection device 3. The camera 21, the GPS receiver 22, the wireless communication terminal 23, and the vehicle appearance information collection device 3 are communicably connected via an in-vehicle network. The vehicle 2 may further include a range sensor (not shown) for measuring a distance to an object around the vehicle 2, such as a LiDAR sensor.

The camera 21, which is an example of a sensor for detecting a situation around the vehicle 2, is attached to the vehicle 2 toward a predetermined area (for example, a front area of the vehicle 2) such that the predetermined area around the vehicle 2 is included in an imaging range of the camera 21. Then, the camera 21 captures the predetermined area every predetermined capturing cycle (for example, 1/30 second to 1/10 second), and generates an image in which the area is represented. The image generated by the camera 21 is an example of a sensor signal. The imaging range of the camera 21 is an example of a detection range of the sensor. The vehicle 2 may be provided with a plurality of cameras 21 taking pictures in different orientations or having different focal lengths.

Each time an image is generated, the camera 21 outputs the generated image to the vehicle appearance information collection device 3 via the in-vehicle network.

The GPS receiver 22 receives GPS signals from GPS satellites at predetermined intervals, and determines the position of the vehicle 2 based on the received GPS signals. Then, the GPS receiver 22 outputs, to the vehicle appearance information collection device 3 via the in-vehicle network, the positioning information indicating the result of determination of the position of the vehicle 2 at predetermined intervals. Note that, instead of the GPS receiver 22, the vehicle 2 may include a receiver conforming to another satellite positioning system and the receiver may determine the position of the vehicle 2.

The wireless communication terminal 23 is a device that executes wireless communication processing conforming to a predetermined wireless communication standard, and is connected to the server 4 via the wireless base station 6 and the communication network 5 by accessing the wireless base station 6. Then, the wireless communication terminal 23 receives the downlink wireless signal including the vehicle location information received from the server 4 via the communication network 5 and the wireless base station 6, and outputs the received vehicle location information to the vehicle appearance information collection device 3. Further, the wireless communication terminal 23 generates an uplink wireless signal including an image representing the target vehicle, which is received from the vehicle appearance information collection device 3. Then, the wireless communication terminal 23 transmits the uplink wireless signal to the wireless base station 6, thereby transmitting the image to the server 4. Further, the wireless communication terminal 23 may include, in an uplink wireless signal for transmitting to the server 4, planned route information indicating a planned traveling route of the vehicle 2 and one or more points on the planned traveling route and the scheduled passing time of each point, which is received from a navigation device (not shown) mounted on the vehicle 2, together with the identification information of the vehicle 2. Furthermore, the wireless communication terminal 23 outputs the dispatch information including the planned parking position of the vehicle 2 or the planned boarding position of the user, which is received from the server 4, to an electronic control unit (ECU, not shown) for controlling the travel of the vehicle 2. Furthermore, the wireless communication terminal 23 may include information indicating the position of the vehicle 2 represented in the positioning information and the direction of the vehicle 2 indicated by an azimuth sensor (not shown) when the vehicle 2 reaches the designated planned parking position in the uplink wireless signal for transmitting to the server 4 together with the identification information of the vehicle 2.

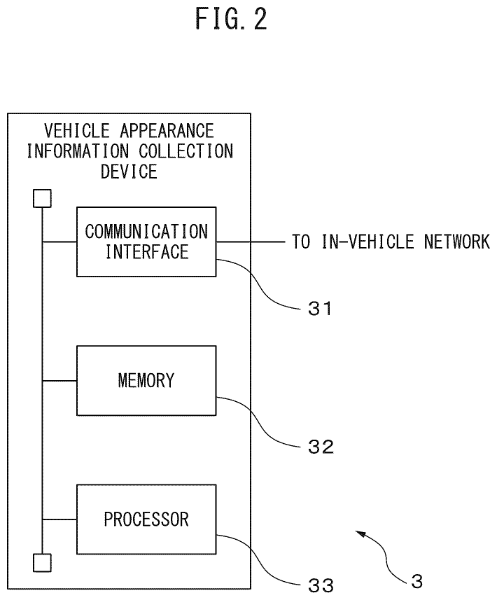

FIG. 2 illustrates the hardware configuration of a vehicle appearance information collection device 3. The vehicle appearance information collection device 3 temporarily stores an image from the cameras 21, positioning information from the GPS receivers 22, and vehicle location information from the servers 4. Further, the vehicle appearance information collection device 3 executes a vehicle appearance information collection process based on the image, the positioning information, and the vehicle location information. To this end, the vehicle appearance information collection device 3 includes a communication interface 31, a memory 32, and a processor 33.

The communication interface 31, which is an example of an in-vehicle communication unit, includes an interface circuit for connecting the vehicle appearance information collection device 3 to the in-vehicle network. In other words, the communication interface 31 is connected to the camera 21, the GPS receiver 22, and the wireless communication terminal 23 via the in-vehicle network. Then, the communication interface 31 passes the image received from the camera 21, the positioning information received from the GPS receiver 22, and the vehicle location information received from the servers 4 via the wireless communication terminal 23 to the processor 33. Furthermore, the communication interface 31 outputs the image in which the target vehicle is detected, which is received from the processor 33, to the wireless communication terminal 23 via the in-vehicle network.

The memory 32, which is an example of a storage unit, includes, for example, a volatile semiconductor memory and a non-volatile semiconductor memory. The memory 32 may further include another storage device such as a hard disk device. The memory 32 stores various types of data used in the vehicle appearance information collection process executed by the processor 33 of the vehicle appearance information collection device 3. For example, the memory 32 stores the identification information of the vehicle 2, parameters of the camera 21 such as the focal length, the shooting direction, and the installation position, and imaging range information representing the imaging range of the camera 21 based on the installation position and the shooting direction of the camera 21 with respect to the vehicle 2 (for example, the angle of view and the maximum distance capable of identifying details of a target vehicle on an image). Further, the memory 32 stores various parameters for specifying the configuration of various classifiers. Further, the memory 32 temporarily stores an image from the camera 21, positioning information from the GPS receivers 22, and vehicle location information received from the servers 4. Further, the memory 32 may store a computer program for implementing each process executed by the processor 33.

The processor 33 includes one or more central processing units (CPUs) and a peripheral circuit thereof. The processor 33 may further include another operating circuit, such as a logic-arithmetic unit, an arithmetic unit, or a graphics processing unit. The processor 33 stores an image received from the camera 21, positioning data received from the GPS receiver 22, and the like in the memory 32. Furthermore, upon receiving the vehicle location information from the server 4, the processor 33 executes the vehicle appearance information collection process.

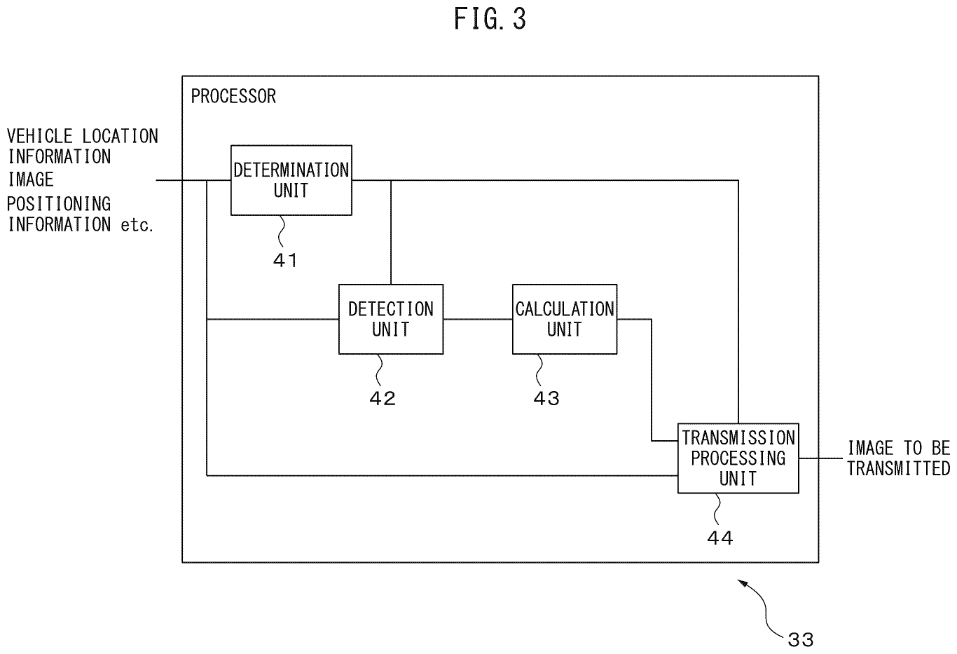

FIG. 3 is a functional block diagram of the processor 33 of the vehicle appearance information collection device 3. The processor 33 includes a determination unit 41, a detection unit 42, a calculation unit 43, and a transmission processing unit 44. Each of these units included in the processor 33 is, for example, a functional module implemented by a computer program executed by the processor 33. Alternatively, each of these units included in the processor 33 may be a dedicated operating circuit provided in the processor 33.

The determination unit 41 determines whether or not the position of the target vehicle indicated by the vehicle location information is included in the imaging range of the camera 21 of the host vehicle.

Herein, the vehicle location information includes, for example, a planned traveling route on which the target vehicle is planned to travel, a position of one or more points on the planned traveling route, and a scheduled passing time of the target vehicle at each point. Alternatively, the vehicle location information may include information indicating a parking position of the target vehicle, an orientation of the target vehicle when parking, and a time period (hereinafter, referred to as a parking time period) during which the target vehicle is parked at the parking position. Further, the vehicle location information may include information for identifying the target vehicle, for example, a vehicle registration number of the target vehicle.

The determination unit 41 specifies the imaging range in the real space based on the position of the vehicle 2 indicated by the latest positioning information (i.e., the position of the host vehicle), the traveling direction of the vehicle 2 indicated by the azimuth sensor (not shown), and the imaging range information stored in the memory 32. In a case where a plurality of cameras 21 are mounted on the vehicle 2, the determination unit 41 specifies the imaging range for each camera. Then, the determination unit 41 specifies a position included in the imaging range in the real space among the positions of the respective points on the planned traveling route and the parking position included in the vehicle location information. When there is no position included in the imaging range, the determination unit 41 determines that the position of the target vehicle is not included in the imaging range of the camera of the host vehicle. On the other hand, when the position of any point on the planned traveling route or the parking position is included in the imaging range in the real space, the determination unit 41 compares the scheduled passing time of the position of the point included in the imaging range or the parking time zone at the parking position included in the imaging range with the current time. When the time difference between the scheduled passing time of the position of the point included in the imaging range and the current time is within a predetermined allowable time, or when the current time is included in the parking time zone at the parking position included in the imaging range, the determination unit 41 determines that the position of the target vehicle is included in the imaging range of the camera 21 of the host vehicle. On the other hand, when the time difference is not included in the allowable time or when the current time is not included in the parking time period, the determination unit 41 determines that the position of the target vehicle is not included in the imaging range of the camera of the host vehicle.

Further, in a case where the position of the target vehicle is included in the imaging range of the camera 21 of the host vehicle, the determination unit 41 specifies the direction of the target vehicle that can be visually recognized from the camera 21 by specifying the relative positional relationship between the target vehicle and the host vehicle based on the direction of the target vehicle that is planned to travel or parked and the position and direction of the host vehicle. For example, in a case where the camera 21 is mounted so as to be oriented to the front of the vehicle and it is assumed that the host vehicle and the target vehicle approach each other from the front direction at the position of the point on the planned traveling route included in the imaging range, the determination unit 41 determines that the orientation of the target vehicle that can be visually recognized from the camera 21 is the front. In addition, when the target vehicle is parked and the host vehicle approaches the target vehicle from the rear of the target vehicle and the target vehicle is included in the imaging range, the determination unit 41 determines that the orientation of the target vehicle that can be visually recognized from the camera 21 is the rear. Further, in a case where the target vehicle passes in front of the host vehicle from right to left and the target vehicle is included in the imaging range during the passage of the target vehicle, the determination unit 41 determines that the orientation of the target vehicle that can be visually recognized from the camera 21 is the left side. Similarly, in a case where the target vehicle passes in front of the host vehicle from left to right and the target vehicle is included in the imaging range during the passage of the target vehicle, the determination unit 41 determines that the orientation of the target vehicle that can be visually recognized from the camera 21 is the right side.

The determination unit 41 notifies the detection unit 42 of a determination result as to whether or not the position of the target vehicle is included in the imaging range of the camera of the host vehicle. Further, when the position of the target vehicle is included in the imaging range of the camera of the host vehicle, the determination unit 41 notifies the calculation unit 43 and the transmission processing unit 44 of the orientation of the target vehicle that can be visually recognized from the camera 21.

When the determination unit 41 determines that the position of the target vehicle is included in the imaging range, the detection unit 42 detects the target vehicle from an image generated by the camera 21. To this end, the detection unit 42 inputs each of at least one image to a classifier trained in advance so as to detect the target vehicle, the at least one image being generated by the camera 21 in a predetermined period (for example, several seconds) before and after the determination unit 41 determines that the position of the target vehicle is included in the imaging range. In a case where, for any one of the input images, the confidence score representing the likelihood that the target vehicle is represented in any region on the image output by the classifier is equal to or greater than a predetermined detection threshold value, the detection unit 42 determines that the target vehicle is represented in the region. In other words, the detection unit 42 determines that the target vehicle is detected from the image. The region in which the target vehicle is represented is hereinafter referred to as an object region. On the other hand, when the confidence score output by the classifier is less than the detection threshold value for any of the regions on any of the images, the detection unit 42 determines that the target vehicle is not detected.

The classifier may be, for example, a deep neural network (DNN) having a convolutional neural network (CNN) type architecture such as Faster R-CNN or Single Shot Multibox Detector. Alternatively, the classifier may be a classifier based on a neural network with attention mechanism such as Vision Transformer, or a machine learning system other than DNN. Such a classifier is trained in advance according to a predetermined learning method such as an error back propagation method using a large number of teacher images including images in which the target vehicle is represented. In particular, in the present embodiment, the target vehicle is limited to a plurality of vehicles 2 under the management of the server 4. Therefore, the classifier is trained so that only a vehicle having the same type and appearance painting as the respective vehicles 2 is detected, thereby improving the detection accuracy of the target vehicle.

When the target vehicle is detected, the detection unit 42 notifies the calculation unit 43 and the transmission processing unit 44 of information indicating an image representing the detected target vehicle, and notifies the calculation unit 43 of information indicating an object region including the target vehicle (for example, coordinate values of respective corners of the object region).

In a case where the target vehicle is detected from the image, the calculation unit 43 inputs the object region in which the target vehicle is represented on the image to a component detection classifier trained in advance so as to calculate, for each of the at least one component of the target vehicle, a confidence score representing the likelihood that the component is represented in the region. Thus, the component detection classifier calculates, for each of the at least one component, the confidence score representing the likelihood that the component is represented in the object region. In the present embodiment, the at least one component of the target vehicle is a component to be inspected for the presence or absence of an appearance defect, and is, for example, any of a glass, headlights, brake lights, a winker, a license plate, a door, a door mirror, or a bumper. The component detection classifier may be a DNN having CNN or attention mechanism. In this case, the component detection classifier calculates, for each of the at least one component and for each of various regions included in the input object region, the confidence score representing the likelihood that the component is represented in the region. Then, the calculation unit 43 sets the highest confidence score of the calculated confidence score as the confidence score of the component.

Note that the calculation unit 43 may resize the object region to a predetermined size (for example, 32×32) by executing a size transform process such as down-sampling, up-sampling, or bicubic interpolation on the object region. The calculation unit 43 may input the resized object region to the component detection classifier. Thus, even if the relative distance between the host vehicle and the target vehicle is not certain and the size of the target vehicle on the image changes, the component detection classifier can treat the object region as a constant size. Therefore, the configuration of the component detection classifier is simplified.

Note that, depending on the component to be the calculation target of the confidence score may be in a blind spot from the camera 21, thereby the component is not represented in the image generated by the camera 21. Therefore, the calculation unit 43 identifies a component visible from the camera 21, that is, a component that is likely to be represented in an image, based on the orientation of the target vehicle visible from the camera 21 notified from the determination unit 41. Then, the calculation unit 43 calculates the confidence score for each of the identified components, and notifies the transmission processing unit 44 of the calculated confidence score. Note that, for each orientation of the target vehicle, a table indicating a relationship between the orientation and the type of a component that can be visually recognized when the target vehicle is viewed from the orientation may be stored in advance in the memory 32. By referring to the table, the calculation unit 43 may identify a component that is likely to be represented in the image with respect to the orientation of the target vehicle visible from the camera 21.

When the target vehicle is detected from the image and the confidence score of any one of the at least one component is less than the predetermined detection threshold, the transmission processing unit 44 transmits the image to the server 4 via the wireless communication terminal 23. The detection threshold value is a value corresponding to a lower limit value of confidence score at which a component is determined to be represented in an image, and may be, for example, the same value as the detection threshold value used for determining whether or not a target vehicle is detected by the detection unit 42.

For a component whose confidence score is less than the detection threshold despite the detection of the target vehicle from the image, there is a possibility that the value of the confidence score calculated for the component is reduced due to the dirty, scratches or deformation of the component. Therefore, the image in which the target vehicle is detected in such a case may represent some defect in the appearance of the target vehicle. Therefore, by uploading such an image to the server 4, it is possible to appropriately check the appearance state of the target vehicle.

On the other hand, when the target vehicle is not detected from the image, the transmission processing unit 44 does not transmit the image to the server 4. For an image in which the target vehicle is not detected, there is a high possibility that the target vehicle is not represented for some reason. For example, at the time of image generation, since another object such as another vehicle is located between the camera 21 of the host vehicle and the target vehicle, thereby the target vehicle is hidden when viewed from the camera 21, and as a result, the target vehicle may not be represented in the image. By not transmitting such an image, the amount of communication between the wireless communication terminal 23 and the server 4 is suppressed. Further, even if the target vehicle is detected from the image, when the confidence score of each component is equal to or greater than the detection threshold, the transmission processing unit 44 does not transmit the image to the server 4. When the confidence score of each component is equal to or higher than the detection threshold value, it is assumed that there is no abnormality in the appearance state of each component, in other words, the dirty of each component is limited and scratches and deformation of each component are also allowed. Therefore, there is a high possibility that a defect in the appearance of the target vehicle is not represented in such an image. Therefore, by omitting such image transmission, the communication amount between the wireless communication terminal 23 and the server 4 is suppressed.

The transmission processing unit 44 may determine whether or not the confidence score of only each component visible from the camera 21 is less than the detection threshold. The transmission processing unit 44 may transmit the image to the server 4 only when the confidence score of any one of the components visible from the camera 21 is less than the detection threshold.

The transmission processing unit 44 may transmit the identification information of the target vehicle indicated by the vehicle location information of the target vehicle determined by the determination unit 41 to be located within the imaging range of the camera 21 to the server 4 together with the image. Thus, in particular, in a case where there are a plurality of target vehicles, the server 4 can easily identify the target vehicle represented in the uploaded image.

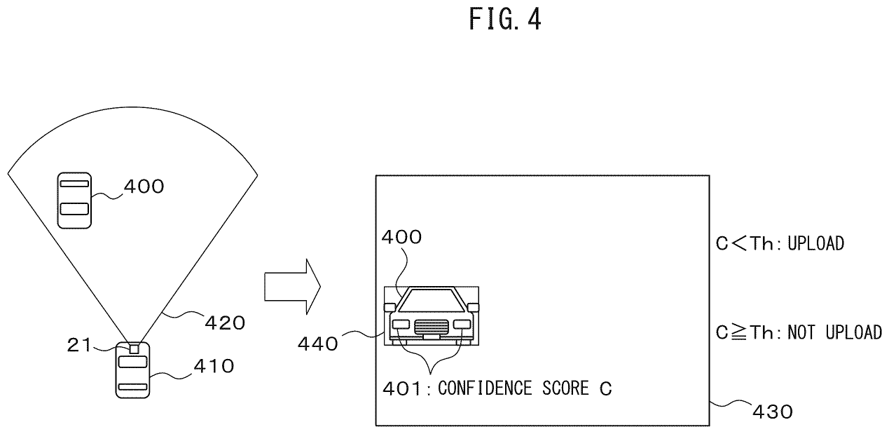

FIG. 4 is a schematic explanatory diagram of a vehicle appearance information collection process. As illustrated in FIG. 4, the target vehicle 400 is detected from the image 430 generated by the camera 21 when the target vehicle 400 is located within the imaging range 420, which is an example of the detection range, of the camera 21 of the host vehicle 410. That is, the image 430 is an example of appearance information representing the appearance of the target vehicle 400. Then, the confidence score C of the component 401 of the target vehicle 400 is calculated for the object region 440 in which the target vehicle 400 is represented on the image 430. When the confidence score C is less than the detection threshold Th, the image 430 is uploaded to the server. On the other hand, when the confidence score C is greater than or equal to the detection threshold Th, the image 430 is not uploaded to the server.

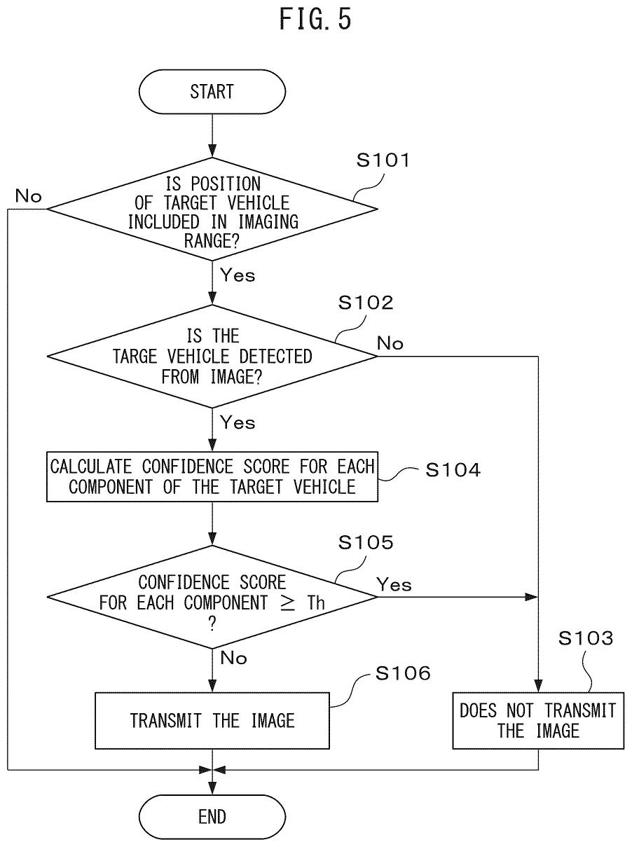

FIG. 5 is an operation flowchart of the vehicle appearance information collection process. When the vehicle appearance information collection device 3 receives the vehicle location information from the server 4, the processor 33 of the vehicle appearance information collection device 3 executes the vehicle appearance information collecting process according to the following operation flowchart.

The determination unit 41 determines whether or not the position of the target vehicle indicated by the vehicle location information is included in the imaging range of the camera 21 of the host vehicle (step S101). When the position of the target vehicle is not included in the imaging range (No in step S101), the processor 33 ends the vehicle appearance information collecting process. On the other hand, when the position of the target vehicle is included in the imaging range (Yes in step S101), the detection unit 42 detects the target vehicle from the image generated by the camera 21 (step S102).

When the target vehicle is not detected from the images (No in step S102), the transmission processing unit 44 does not transmit the image to the server 4 (step S103). On the other hand, when the target vehicle is detected from the image (Yes in step S102), the calculation unit 43 calculates the confidence score of each component of the target vehicle in the object region in which the target vehicle is represented on the image (step S104).

The transmission processing unit 44 determines whether or not the confidence score of each component is equal to or greater than the detection threshold Th (step S105). When the confidence score of all the components are equal to or higher than the detection threshold Th (Yes in step S105), the transmission processor 44 does not transmit the image to the server 4 (step S103). On the other hand, when the confidence score of any one of the components is less than the detection threshold Th (No in step S105), the transmission processing unit 44 transmits the image to the server 4 via the wireless communication terminal 23 (step S106).

After step S103 or step S106, the processor 33 ends the vehicle appearance information collection process.

Next, the server 4 will be described. The server 4 manages a plurality of vehicles 2. In the present embodiment, the server 4 generates vehicle location information that specifies, among the plurality of vehicles 2, a vehicle whose elapsed time since the reception of an image representing the vehicle has passed a predetermined period or a vehicle designated by the administrator via the user interface of the server 4 as a target vehicle. At this time, the server 4 includes, in the vehicle location information, the identification information of the target vehicle, the planned traveling route which is included in the planned route information received from the target vehicle, or is set by the dispatch server (not shown) in response to a dispatch request from the user, one or more points on the route and the scheduled passing time of each point. Alternatively, the server 4 may include, in the vehicle location information, the parking position and the orientation of the target vehicle at the time of parking received from the target vehicle, and the parking time period set by the dispatch management or the like. The server 4 transmits the vehicle location information about the target vehicle to any one of the plurality of vehicles 2 other than the target vehicle via the communication network 5 and the wireless base station 6. At this time, the server 4 may select, among the plurality of vehicles 2, a vehicle located within a predetermined distance from the current position of the target vehicle, for example, as the vehicle to which the vehicle location information is to be transmitted, or may transmit the vehicle location information to all the vehicles 2 other than the target vehicle. Further, when the server 4 receives an image representing the target vehicle from any of the plurality of vehicles 2, it is determined whether or not there is any defect in the appearance of the target vehicle based on the received image. Note that the determination may be performed by the administrator visually viewing an image, or the server 4 itself may execute by inputting the image to a classifier for determining an appearance defect, or by comparing the image with a reference image representing a target vehicle in a normal state. The target vehicle determined to have a defect may be managed so as not to be dispatched until the defect is repaired.

As described above, the vehicle appearance information collection device detects the target vehicle from the image generated by the camera mounted on the host vehicle. Further, the vehicle appearance information collection device calculates, for the object region in which the target vehicle is represented on the image, a confidence score in which the component is represented for each of the at least one component of the target vehicle. The vehicle appearance information collection device transmits the image to the server when the target vehicle is detected from the image and the confidence score of any one of the components is less than a predetermined detection threshold. As a result, the vehicle appearance information collection device can transmit an image suitable for inspection of the appearance state of the target vehicle to the server while suppressing an increase in the amount of communication by limiting an image to be transmitted to the server to the one that is highly likely to represent a defect in the appearance of the target vehicle.

Note that a range sensor such as a LiDAR mounted on the host vehicle may be used instead of the camera 21 as a sensor for detecting a state around the vehicle. In this case, when the position of the target vehicle is included in the detection range of the range sensor, the detection unit 42 detects the target vehicle by inputting a ranging signal, which is generated by the range sensor and represents, for each azimuth, a distance to an object existing in the azimuth to a classifier for detecting the target vehicle. The ranging signal is another example of a sensor signal. In addition, the calculation unit 43 may calculate the confidence score of each component by inputting the range of the azimuth in which the target vehicle is represented on the range signal to the classifier for confidence score calculation. In this embodiment, the classifier for detecting the target vehicle and the classifier for calculating the confidence score may be DNN having a CNN architecture or attention mechanism. Then, the transmission processing unit 44 transmits, to the server 4, the ranging signal in which the target vehicle is detected and the confidence score of any one of the components is less than the detection threshold.

According to the modification, when the image in which the target vehicle is detected is transmitted to the server 4, the transmission processing unit 44 may also transmit a ranging signal generated by the range sensor to the server 4 within a predetermined period (for example, several seconds) from the time of image generation. Similarly, when transmitting the ranging signal detected by the target vehicle to the server 4, the transmission processing unit 44 may also transmit an image generated by the camera 21 within a predetermined period from the time of generating the ranging signal to the server 4. Further, when a microphone for collecting sound around the host vehicle may be provided in the host vehicle. In this case, when the image or the ranging signal in which the target vehicle is detected is transmitted to the server 4, the transmission processing unit 44 may also transmit the sound signal generated by the microphone within a predetermined period from the time of generating the image or the ranging signal to the server 4.

As described above, a skilled person can make various modifications according to the embodiment within the scope of the present invention.

What is claimed is:

1. A vehicle appearance information collection device comprising;
a processor configured to:
determine whether or not a position of a target vehicle indicated by vehicle location information is included in a detection range of a sensor of a host vehicle,
detect the target vehicle from the sensor signal generated by the sensor when the position of the target vehicle is included in the detection range,
calculate, for each of at least one component of the target vehicle, a confidence score that the component is represented in a region in which the target vehicle is represented on the sensor signal by inputting the region to a classifier trained in advance so as to detect the at least one component of the target vehicle, when the target vehicle is detected from the sensor signal, and
transmit the sensor signal to a server via a wireless communication terminal mounted on the host vehicle when the target vehicle is detected and the confidence score of any one of the at least one component is less than a predetermined detection threshold.

2. The vehicle appearance information collection device according to claim 1, wherein
the processor is further configured to determine a relative positional relationship between the target vehicle and the host vehicle when the position of the target vehicle is included in the detection range, wherein
the processor calculates the confidence score of a component visible from the sensor in the relative positional relationship between the target vehicle and the host vehicle among the at least one component, and
transmits the sensor signal to the server only when the confidence score of the component visible from the sensor among the at least one component is less than the detection threshold.

3. A vehicle appearance information collection method comprising:
determining whether or not a position of a target vehicle indicated by vehicle location information is included in a detection range of a sensor of a host vehicle;
detecting the target vehicle from the sensor signal generated by the sensor when the position of the target vehicle is included in the detection range;
calculating, for each of at least one component of the target vehicle, a confidence score that the component is represented in a region in which the target vehicle is represented on the sensor signal by inputting the region to a classifier trained in advance so as to detect the at least one component of the target vehicle, when the target vehicle is detected from the sensor signal; and
transmitting the sensor signal to a server via a wireless communication terminal mounted on the host vehicle when the target vehicle is detected and the confidence score of any one of the at least one component is less than a predetermined detection threshold.

4. A non-transitory recording medium that stores a computer program for collecting vehicle appearance information, the computer program causing a processor mounted on a host vehicle to execute a process comprising:
determining whether or not a position of a target vehicle indicated by vehicle location information is included in a detection range of a sensor of a host vehicle;
detecting the target vehicle from the sensor signal generated by the sensor when the position of the target vehicle is included in the detection range;
calculating, for each of at least one component of the target vehicle, a confidence score that the component is represented in a region in which the target vehicle is represented on the sensor signal by inputting the region to a classifier trained in advance so as to detect the at least one component of the target vehicle, when the target vehicle is detected from the sensor signal; and
transmitting the sensor signal to a server via a wireless communication terminal mounted on the host vehicle when the target vehicle is detected and the confidence score of any one of the at least one component is less than a predetermined detection threshold.
